(19) United States
(12) Patent Application Publication
(10) Pub. No.: US 2009/0161553 A1
(43) Pub. Date: Jun. 25, 2009

(54) APPARATUS FOR ANALYZING UBIQUITOUS SENSOR NETWORK PROTOCOL

(75) Inventors: Se Han KIM, Daejeon-city (KR); Kyeseon Lee, Daejeon-city (KR); Nae Soo Kim, Daejeon-city (KR); Cheol Sig Pyo, Daejeon-city (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon-city (KR)

(21) Appl. No.: 12/338,458

(22) Filed: Dec. 18, 2008

(30) Foreign Application Priority Data
Dec. 18, 2007 (KR) 10-2007-0133741

(51) Int. Cl. H04L 12/26

(52) U.S. Cl. 370/241

(57) ABSTRACT

An apparatus for analyzing a USN protocol includes a packet analyzer and a protocol analyzer. The packet analyzer collects packets communicated between USN sensor nodes through at least one or more channels. The protocol analyzer processes/displays the collected packets using an XML schema defined according to the USN protocol. Thus, the USN protocol analyzing apparatus can decode/encode packets collected through a plurality of channels.

### CROSS-REFERENCE TO RELATED PATENT APPLICATION

This application claims the benefit of Korean Patent Application No. 10-2007-0133741, filed on Dec. 18, 2007, in the Korean Intellectual Property Office, the disclosure of which is incorporated herein in its entirety by reference.

### BACKGROUND OF THE INVENTION

1. Field of the Invention

The present invention relates to an apparatus for analyzing a ubiquitous sensor network (USN) protocol, and more particularly, to an apparatus for analyzing various protocols used in a ubiquitous sensor network (USN)/wireless sensor network (WSN).

The present invention is derived from a research project supported by the Information Technology (IT) Research & Development (R&D) program of the Ministry of Information and Communication (MIC) and the Institute for Information Technology Advancement (IITA) [2005-S-106-03, Development of Sensor Tag and Sensor Node Techniques for RFID/USN].

2. Description of the Related Art

In general, a ubiquitous sensor network (USN) manages diverse sensor nodes that communicate information using packets. For use of the USN, the contents of packets communicated between sensor nodes must be grasped and transmitted to users. To this end, it is necessary to analyze the USN protocol. A conventional USN protocol analyzer can only analyze a specific protocol, such as a ZigBee protocol, and a single channel. That is, the conventional art can implement only a predefined protocol regardless of users' intentions. Also, because the convention art can analyze only a single channel, it has a limitation in analyzing various protocols.

### SUMMARY OF THE INVENTION

The present invention provides a USN protocol analyzing apparatus that includes a plurality of transceivers and can analyze a plurality of channels simultaneously by analyzing protocols using a predefined USN protocol, thereby making it possible to analyze various protocols based on user definitions (e.g., XML schemas).

According to an aspect of the present invention, there is provided an apparatus for analyzing a USN protocol, the apparatus including: a packet analyzer collecting packets communicated between USN sensor nodes through at least one or more channels; and a protocol analyzer processing/displaying the collected packets using an XML schema defined according to the USN protocol.

The packet analyzer may include at least one or more transceivers, and may collect packets communicated between USN sensor nodes through at least one or more channels.

The packet analyzer may include: a communication connector connected to the protocol analyzer to transmit/receive packets; a memory storing the collected packets; and a TX/RX engine performing a control operation for transmitting the collected packets to the protocol analyzer.

The protocol analyzer may include: a personal computer mounted with a user program including: a protocol schema defining a USN protocol; an XML engine defining an XML schema according to the defined USN protocol and generating a GUI; and a translator encoding/decoding the collected packets using the defined XML schema.

The apparatus may further include a socket manager transmitting/receiving the collected packets, wherein the translator uses the XML schema to decode the packet received through the socket manager.

The XML engine may include: an XML generator defining the XML schema according the USN protocol defined by the protocol schema; and a GUI generator generating the GUI using the XML schema defined by the XML generator.

The GUI generator may generate the GUI including channel search, packet collection, packet generation, and statistics collection by using the XML schema defined by the XML generator.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a USN protocol analyzing apparatus according to an embodiment of the present invention;

FIG. 2 is a diagram defining the protocol for communication between a packet analyzer and a protocol analyzer of FIG. 1 according to an embodiment of the present invention;

FIG. 3 is a diagram defining the respective packet types of FIG. 2 according to an embodiment of the present invention;

FIGS. 4A through 4P are diagrams illustrating the structures of actual packets defined depending on the packet types of FIG. 3 according to an embodiment of the present invention;

FIG. 5 is a block diagram of the protocol analyzer of FIG. 1 according to an embodiment of the present invention; and

FIGS. 6A-6C and 7 through 13 are diagrams illustrating the USN protocols defined in a protocol schema according to an embodiment of the present invention.

### DETAILED DESCRIPTION OF THE INVENTION

The present invention will now be described more fully with reference to the accompanying drawings, in which exemplary embodiments of the invention are shown.

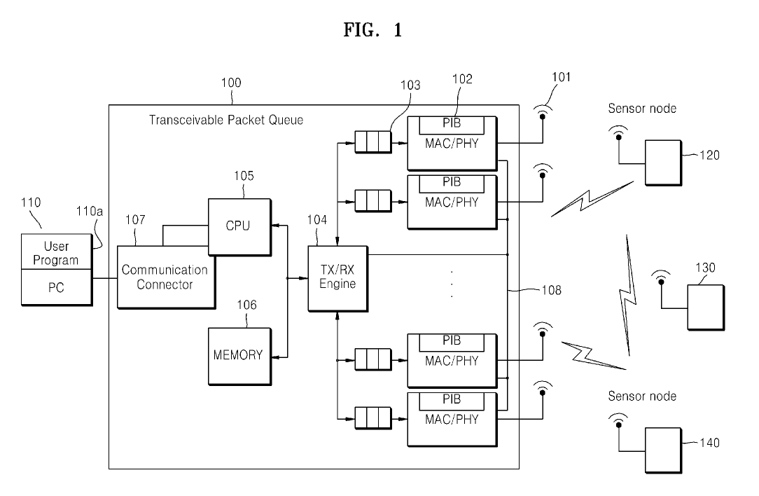

FIG. 1 is a block diagram of a USN protocol analyzing apparatus according to an embodiment of the present invention.

Referring to FIG. 1, a USN protocol analyzing apparatus according to an embodiment of the present invention includes a packet analyzer 100 and a protocol analyzer 110.

The packet analyzer 100 analyzes packets communicated between sensor nodes 120, 130 and 140 through one or more channels.

The packet analyzer 100 is an independent hardware and includes one or more antennas 101, one or more transceivers 102, one or more transceiver buffers 103 corresponding to the respective transceivers 102, a transmit/receive (TX/RX) engine 104, a central processing unit (CPU) 105, a memory 106, and a communication connector 107.

As illustrated in FIG. 1, the packet analyzer 100 includes one or more transceivers 103 that transmit/receive frames through the antennas 101 according to a packet or a command received from the protocol analyzer 110. Herein, the number of the antennas 101 may be equal to the number of the transceivers 103, or only one antenna 101 may be provided regardless of the number of the transceivers 103. If only one antenna 101 is provided, a channel is fixed in order to reduce the effect of interference.

The packet analyzer 100 and the protocol analyzer 110 are connected through the communication connector 107. Examples of the type of the communication connector 107 include Ethernet, wireless LAN, USB, GSM, and CDMA. Thus, the packet analyzer 100 and the protocol analyzer 110 transmits/receives packets through the communication connector 107.

The packet analyzer 100 communicates packets with the protocol analyzer 110. In a TX mode, a packet generated by the protocol analyzer 110 is transferred through the CPU 105, the memory 106, the TX/RX engine 104 and the corresponding transceiver buffer 103 to the transceiver 102. In an RX mode, a packet received through the antenna 101 and the transceiver 102 is transferred to the transceiver buffer 103 and the packet is transferred through the CPU 105 and the memory 106 to the protocol analyzer 110 under the control of the TX/RX engine 104. At this point, the memory 106 stores the collected packet.

The packet analyzer 100 includes a plurality of the transceivers 102 and transmits/receives packets through the transceivers 102. In this case, the packet analyzer 100 compares packets transmitted/received through the respective channels, controls transmission of the packets, and includes a synchronization line 108 to synchronize time between the TX/RX engine 104 and each of the transceivers 102.

Examples of the protocol analyzer 110 include a personal computer (PC) mounted with a user program 110a.

The protocol analyzer 110 analyzes a protocol by parsing an XML schema that is a document defining a protocol spec desired by the user, and generates a protocol defined by the user.

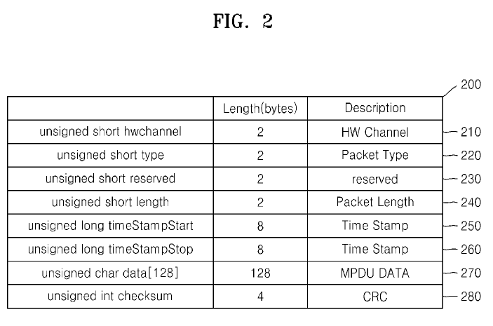

FIG. 2 is a diagram defining the protocol for communication between the packet analyzer 100 and the protocol analyzer 110 of FIG. 1 according to an embodiment of the present invention. Herein, a software mounted on the packet analyzer 100 operates as a server, while the user program 110a operates as a client. The packet analyzer 100 and the protocol analyzer 110 communicate with each other according to the protocol defined in FIG. 2.

FIG. 2 illustrates a packet structure necessary for communication between a server and a client according to an embodiment of the present invention.

Referring to FIG. 2, a packet structure 200 includes: a field of each transceiver 210 included in the packet analyzer 100; a field of a packet type 220 used between the server and the client; a reserved field 230 commonly used; a field of a packet length 240 indicating the data length of a packet; a field of start/stop time stamps 250 and 260; a field of 128-byte data 270 for actual transmission/reception; and a CRC field 280. The use of the respective fields is defined according to the packet types 220.

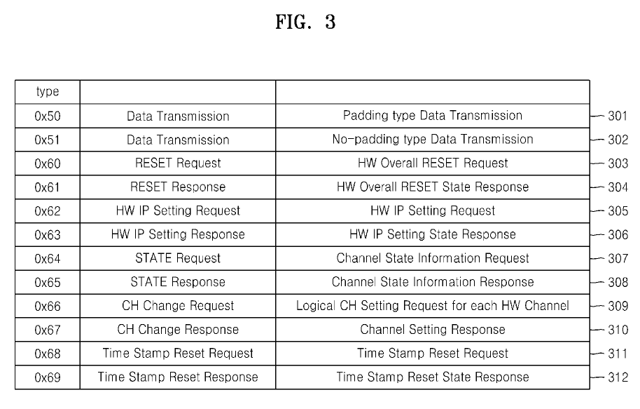

FIG. 3 is a diagram defining the packet types of FIG. 2 according to an embodiment of the present invention.

Referring to FIG. 3, the packet types may be classified into 0x50 (301), 0x51 (302), and 0x60 (303) through 0x69 (312).

The packet types 0x50 (301) and 0x51 (302) define actual TX/RX data. The packet types 0x60 (303) through 0x69 (312) control the packet analyzer 100 or define the type necessary for reception information from the packet analyzer 100.

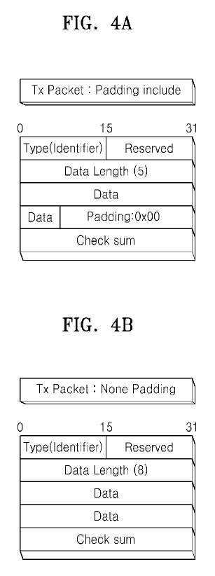

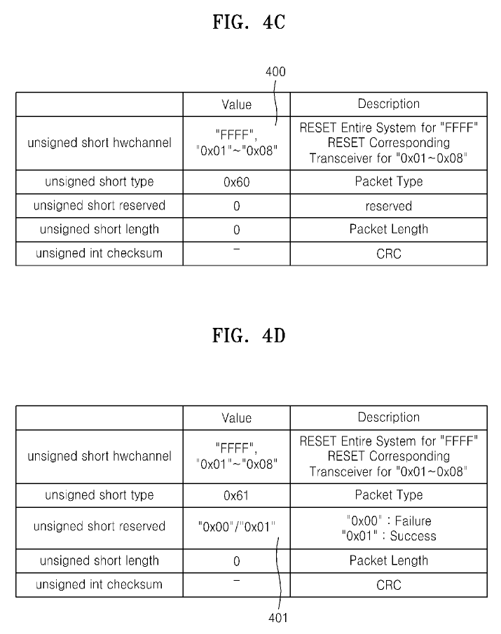

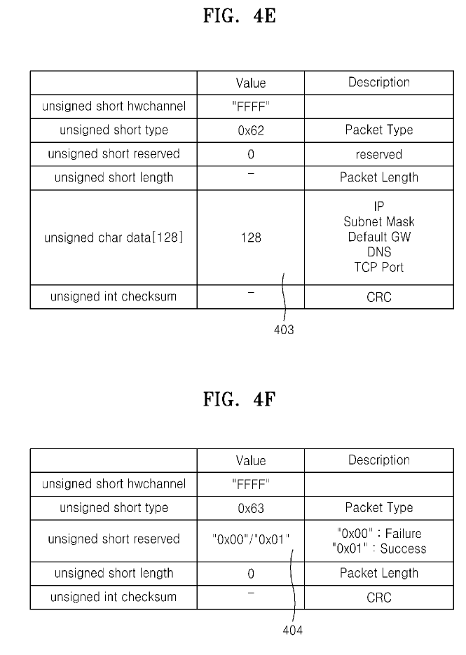

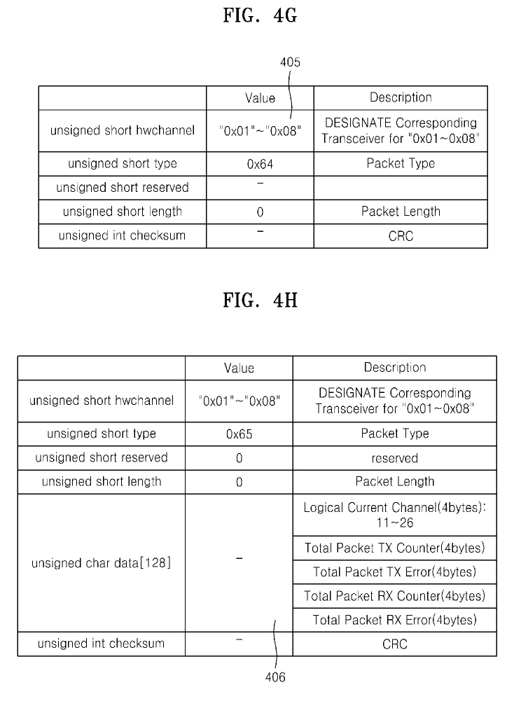

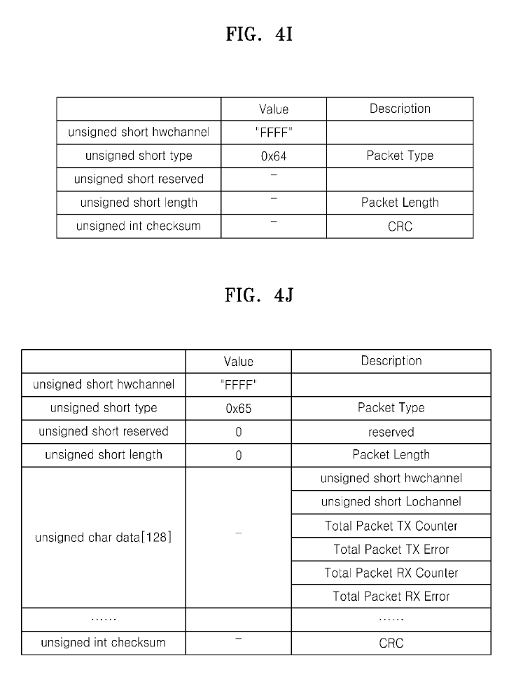

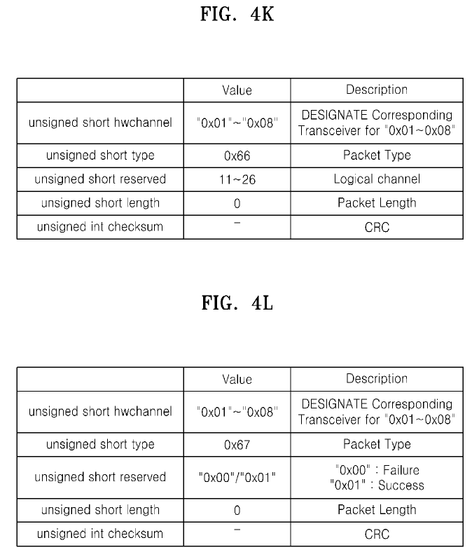

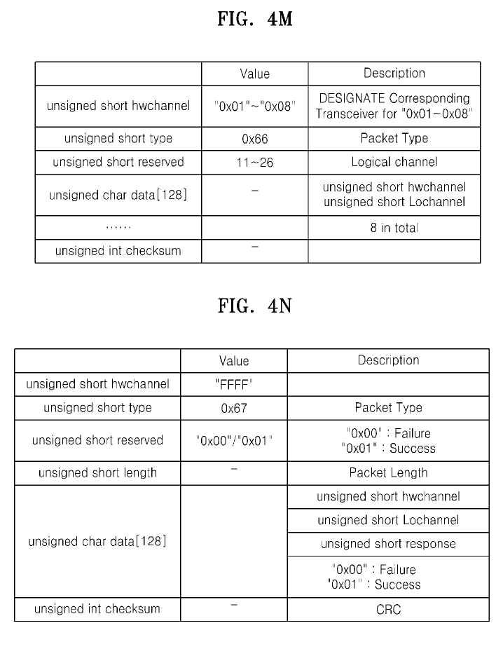

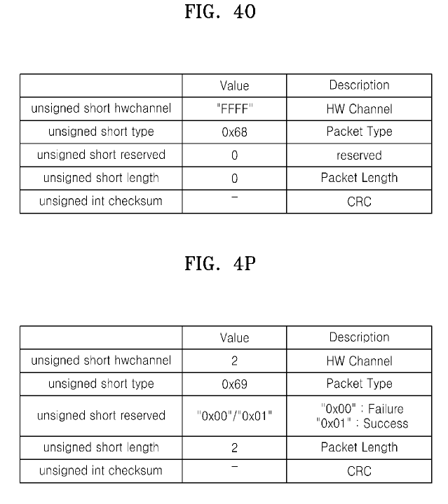

FIGS. 4A through 4P are diagrams illustrating the structures of actual packets defined depending on the packet types of FIG. 3 according to an embodiment of the present invention.

Hereinafter, the packet structures illustrated in FIGS. 4A through 4P will be described in detail with reference to FIGS. 2 and 3.

FIG. 4A illustrates an actual packet structure when the packet type is 0x50 according to an embodiment of the present invention. FIG. 4B illustrates an actual packet structure when the packet type is 0x51.

According to an embodiment of the present invention, the packet types 0x50 and 0x51 indicate packets necessary for actual transmission/reception. The packet structures of the packet types 0x50 and 0x51 are classified according to whether padding information is used or not. If padding values (e.g., an RSSI value, a CRC result, and a correlation value) are used, data are transmitted using the structure illustrated in FIG. 4A. If padding is not used, only an actual packet is transmitted as illustrated in FIG. 4B.

FIG. 4C illustrates an actual packet structure when the packet type is 0x60 according to an embodiment of the present invention. If the packet type is 0x60, the packet RESET REQUEST is used to reset the packet analyzer (i.e., a hardware system). As illustrated in FIG. 4C, if a defined hardware channel value 400 is “FFFF”, the entire system of the packet analyzer is reset; and if a specific transceiver is designated, only the designated transceiver is reset.

FIG. 4D illustrates an actual packet structure when the packet type is 0x61 according to an embodiment of the present invention. If the packet type is 0x61, the packet is used to transmit the processing results of a packet with the type 0x60. The success or failure of the reset of the entire or part of the system is transmitted according to a defined hardware channel value. That is, if a defined reserved value 401 is “0x00”, the failure is transmitted; and if the defined reserved value 401 is “0x01”, the success is transmitted.

FIG. 4E illustrates an actual packet structure when the packet type is 0x62 according to an embodiment of the present invention. If the packet type is 0x62, the packet is used to set a hardware IP when an operation is based on the hardware IP. An IP, subnet mask, default, GW, DNS and TCP port may be changed using a data field 403.

FIG. 4F illustrates an actual packet structure when the packet type is 0x63 according to an embodiment of the present invention. If the packet type is 0x63, the packet is used to transmit the processing results of a packet with the type 0x62, which informs the success or failure of an IP setting change request. That is, if a defined reserved value 401 is “0x00”, the failure is transmitted; and if the defined reserved value 401 is “0x01”, the success is transmitted.

FIG. 4G illustrates an actual packet structure for request for the state of a specific channel when the packet type is 0x64 according to an embodiment of the present invention. If the packet type is 0x64, the state of a specific channel is requested. In this case, as illustrated in FIG. 4G, the state information of a specific transceiver of hardware is requested. If a defined hardware channel value 405 is “0x01”˜“0x08, the state information of a designated transceiver is requested.

FIG. 4H illustrates an actual packet structure for a response to the state request for a specific channel when the packet type is 0x65 according to an embodiment of the present invention. If the packet type is 0x65, information of a TX counter, the number of TX errors, an RX counter, and the number of RX errors are responded to the specific channel state request.

FIG. 4I illustrates an actual packet structure for request for the state of the entire channel when the packet type is 0x64 according to an embodiment of the present invention. If the packet type is 0x64, the state of the entire channel is requested. In this case, as illustrated in FIG. 4G, a hardware channel value is set to “FFFF”. Then, the state information of the entire hardware transceiver is requested.

FIG. 4J illustrates an actual packet structure for a response to the state request for the entire channel when the packet type is 0x65 according to an embodiment of the present invention. If the packet type is 0x65, the state request for the entire channel is responded. In this case, as illustrated in FIG. 4J, a hardware channel value is set to “FFFF”. Then, information of a TX counter, the number of TX errors, an RX counter, and the number of RX errors are responded as a response to the entire hardware transceiver.

FIG. 4K illustrates an actual packet structure for a request for a channel change of a specific channel when the packet type is 0x66 according to an embodiment of the present invention. A channel change of a specific channel may be requested through a packet illustrated in FIG. 4K.

FIG. 4L illustrates an actual packet structure for a response to a specific channel change request when the packet type is 0x67 according to an embodiment of the present invention. The success or failure of the specific channel change request may be responded through a packet illustrated in FIG. 4L.

FIG. 4M illustrates an actual packet structure for a request for a change of the entire channel when the packet type is 0x66 according to an embodiment of the present invention. A channel change of the entire channel may be requested through a packet illustrated in FIG. 4M.

FIG. 4N illustrates an actual packet structure for a response to an entire channel change request when the packet type is 0x67 according to an embodiment of the present invention. The success or failure of the entire channel change request may be responded through a packet illustrated in FIG. 4N.

FIG. 4O illustrates an actual packet structure when the packet type is 0x68 according to an embodiment of the present invention. The reset of a circuit for time synchronization for each transceiver may be requested through a packet structure illustrated in FIG. 4O.

FIG. 4P illustrates an actual packet structure when the packet type is 0x69 according to an embodiment of the present invention. The packet of FIG. 4O may be responded through a packet structure illustrated in FIG. 4P. As illustrated with reference to FIGS. 2, 3, and 4A through 4P, the packet analyzer 100 and the protocol analyzer 110 of FIG. 1 define the protocol according to FIG. 2, and perform communication using the actual packets (FIGS. 4A through 4P) according to the packet types defined in FIG. 3.

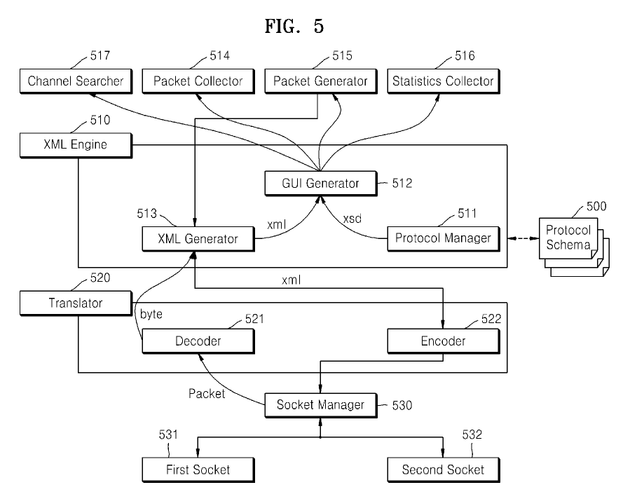

FIG. 5 is a block diagram of the protocol analyzer 110 of FIG. 1 according to an embodiment of the present invention.

Referring to FIG. 5, the protocol analyzer 110 according to an embodiment of the present invention includes a protocol schema 500, an XML engine 510, a translator 520, and a socket manager 530. The protocol schema 500 defines a USN protocol according to an embodiment of the present invention. For example, the protocol schema 500 defines a protocol, which is defined by the user, in an XML format.

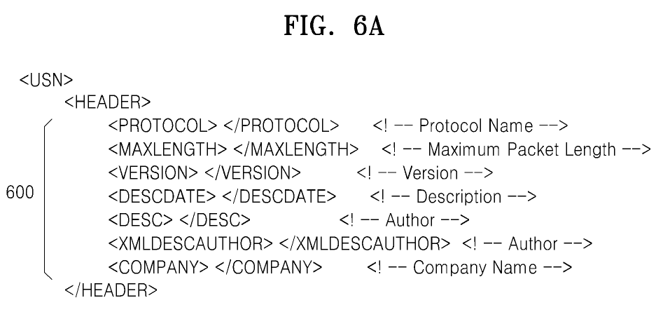

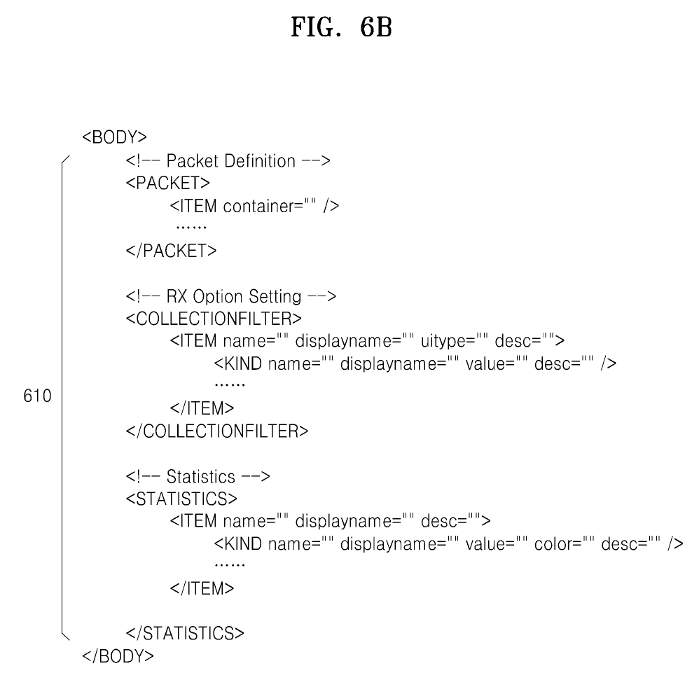

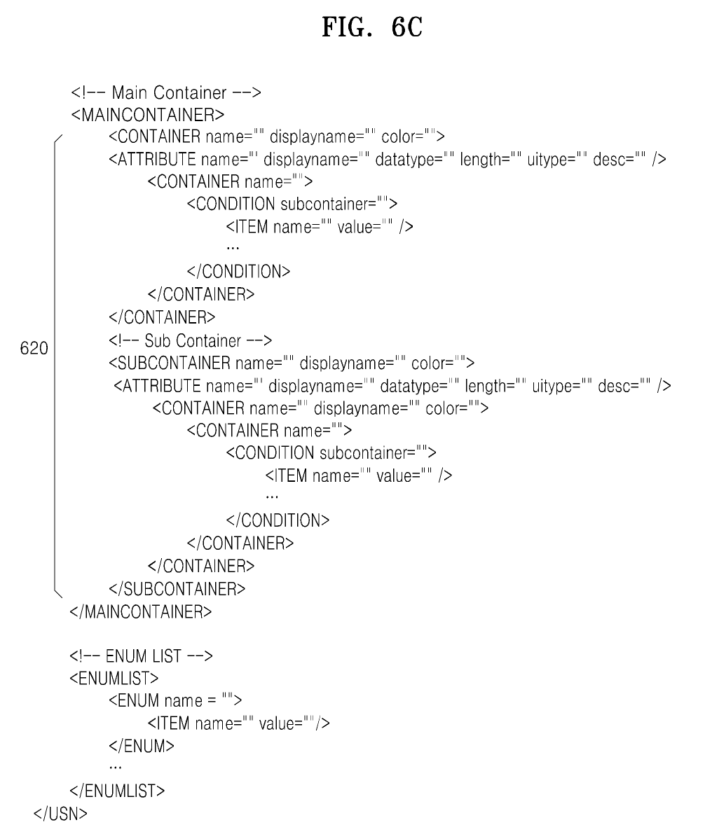

FIGS. 6A-6C and 7 through 13 are diagrams illustrating the USN protocols defined in a protocol schema according to an embodiment of the present invention.

Hereinafter, the USN protocols defined in a protocol schema according to an embodiment of the present invention will be described in detail with reference to FIGS. 6A-6C and 7 through 13.

FIG. 6A-6C illustrates the entire structure of an XML for defining a protocol according to an embodiment of the present invention.

Referring to FIG. 6A-6C, the XML for defining the protocol includes: a header section 600 containing information of a file; a body section 610 defining packet definition, TX/RX options and statistics; and a main container section 620 defining the respective sections.

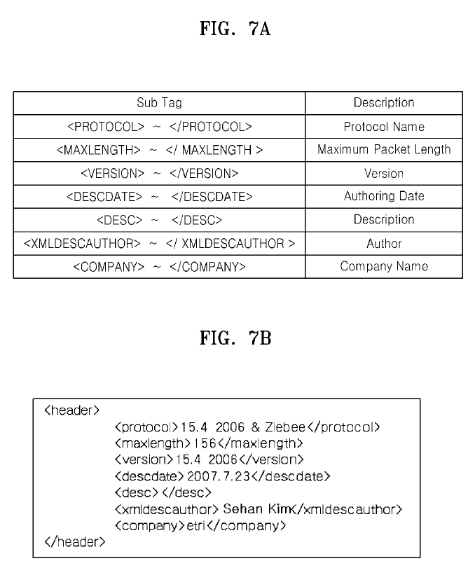

FIGS. 7A and 7B illustrate the detailed definition of the header section of FIG. 6A-6C. FIG. 7A illustrates the definition of a sub tag of the header section of FIG. 6A-6C, wherein the header section means a section between <HEADER> and </HEADER> tags. The header section includes: a protocol name 700 defined by the user; the maximum packet length 710; a protocol version 720; an XML authoring date 730; an XML file description 740; an author 750; and a company name 760. FIG. 7A illustrates an example of the header section of FIG. 6A-6C, which is actually authored and used.

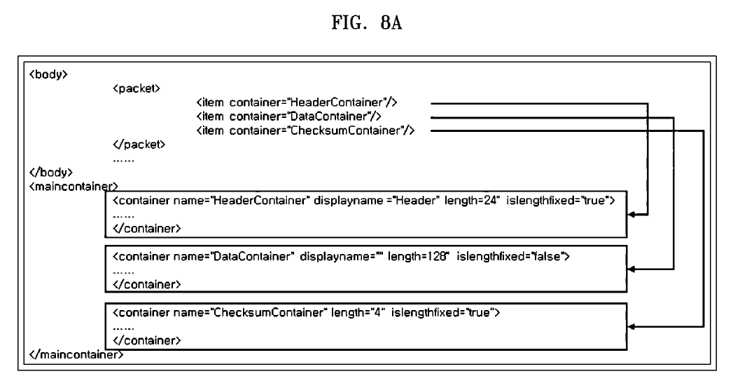

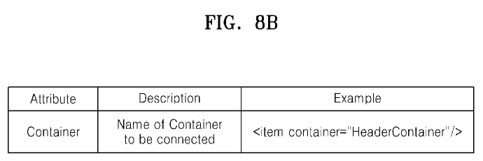

FIGS. 8A and 8B illustrate the detailed definition of a packet in the body section of FIG. 6A-6C. FIG. 8A defines a packet in a <BODY>˜</BODY> tag section of the body section of FIG. 6A-6C. As illustrated in FIG. 8A, the respective packets describe HEADER, DATA and CHECKSUM in a “name” portion of <item container=“name”/>. The contents described in a “name” portion of each <item> are linked with <container>˜</container> defined in <maincontainer>˜</maincontainer>. Herein, the attribute of container of <item> is the same as illustrated in FIG. 8B.

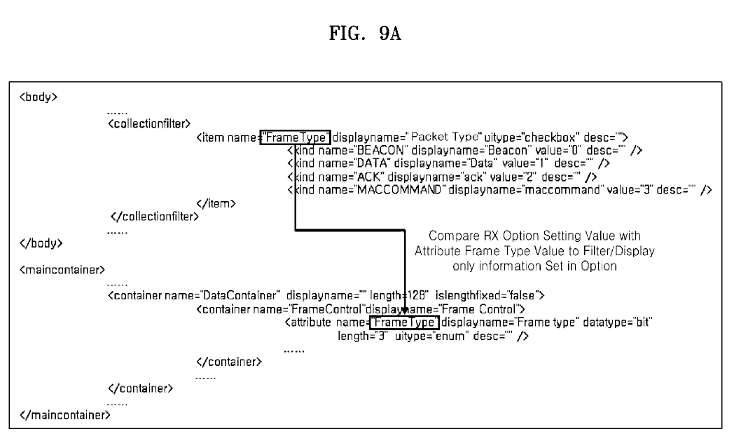

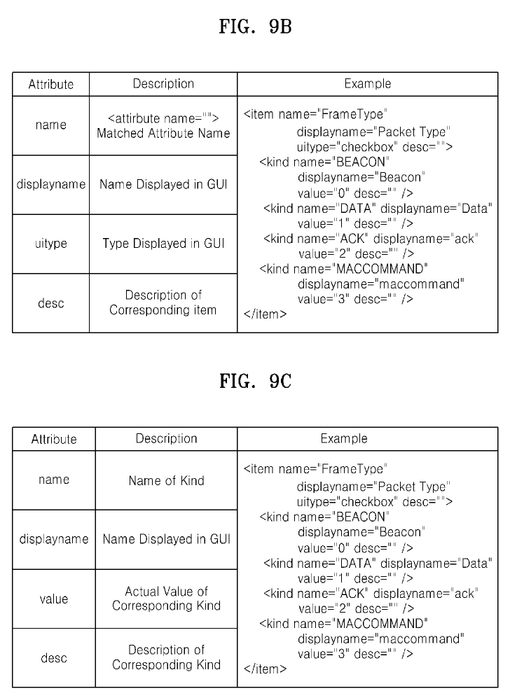

FIGS. 9A through 9C illustrate the detailed definition of an RX option in the body section of FIG. 6A-6C. FIG. 9A defines an RX option of the packet analyzer in a <COLLECTIONFILTER>˜</COLLECTIONFILTER> tag section of the body section of FIG. 6A-6C. As illustrated in FIG. 9A, the detailed setting items of the RX option are defined in the <item> tag, and the contents described in the “name” portion are linked with <attribute>. FIG. 9B illustrates the attribute and use of the <item> tag according to an embodiment of the present invention, and FIG. 9C illustrates the attribute and use of the <kind> tag according to an embodiment of the present invention.

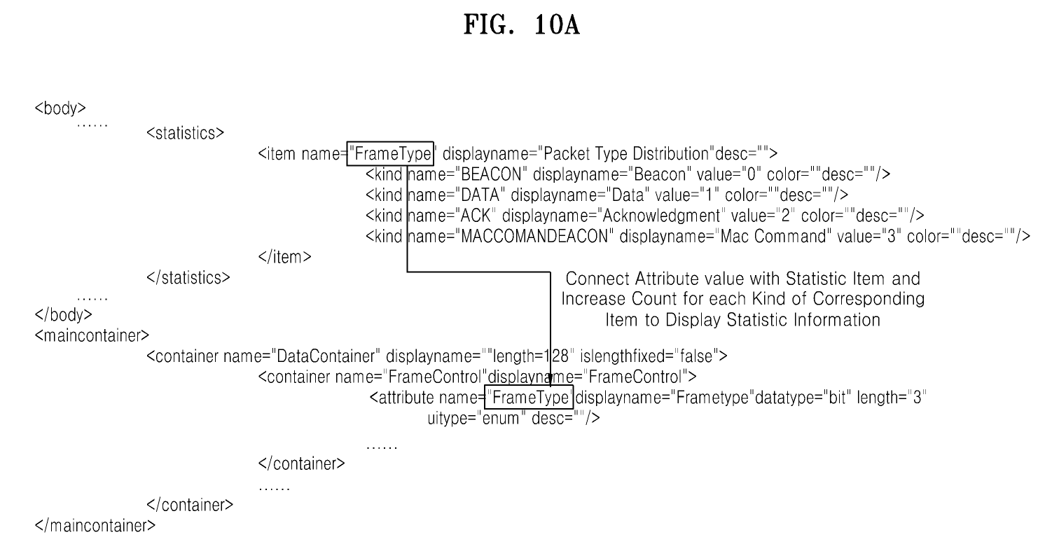

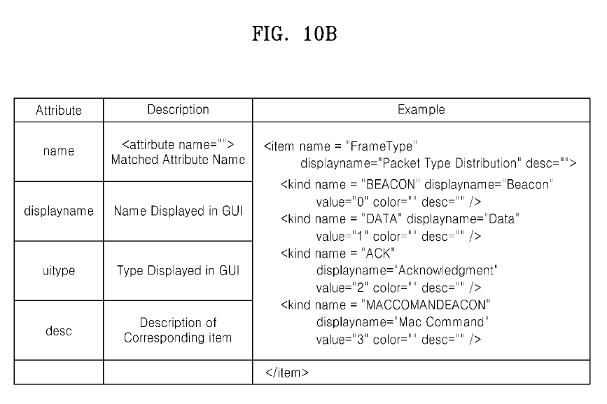

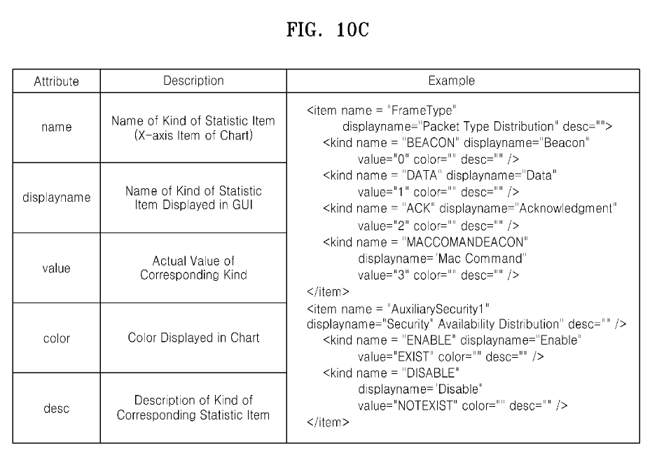

FIGS. 10A through 10C illustrate the detailed definition of the statistics in the body section of FIG. 6A-6C. FIG. 10A defines the statistic item and type for collection of information by the packet analyzer in a <STATISTICS>˜</STATISTICS> tag section of the body section of FIG. 6A-6C. As illustrated in FIG. 10A, an <item> tag describes a statistics item, and the contents described in the “name” portion are linked with <attribute>. Also, the type of each statistic item is described in a <kind> tag subordinate to the <item> tag. If the portion described in “name” of <item> is linked with the portion described in “name” of a <container> tag, the statistics are collected by determining whether the corresponding container exists in the value of the <kind> tag using “EXIST” and “NOEXIST”. FIG. 10B illustrates the attribute and use of the <item> tag according to an embodiment of the present invention, and FIG. 10C illustrates the attribute and use of the <kind> tag according to an embodiment of the present invention.

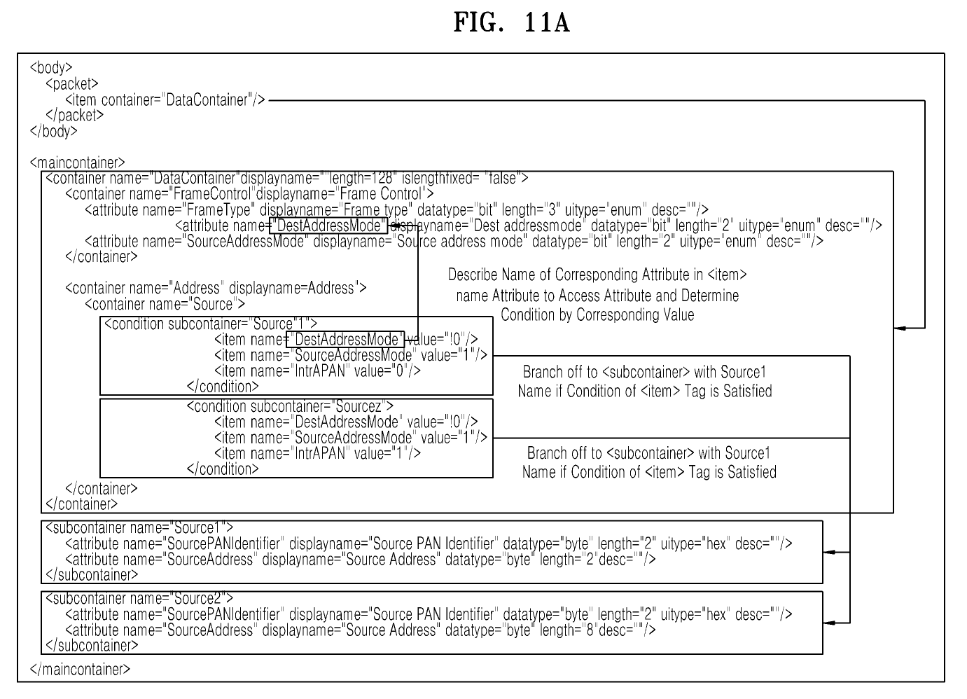

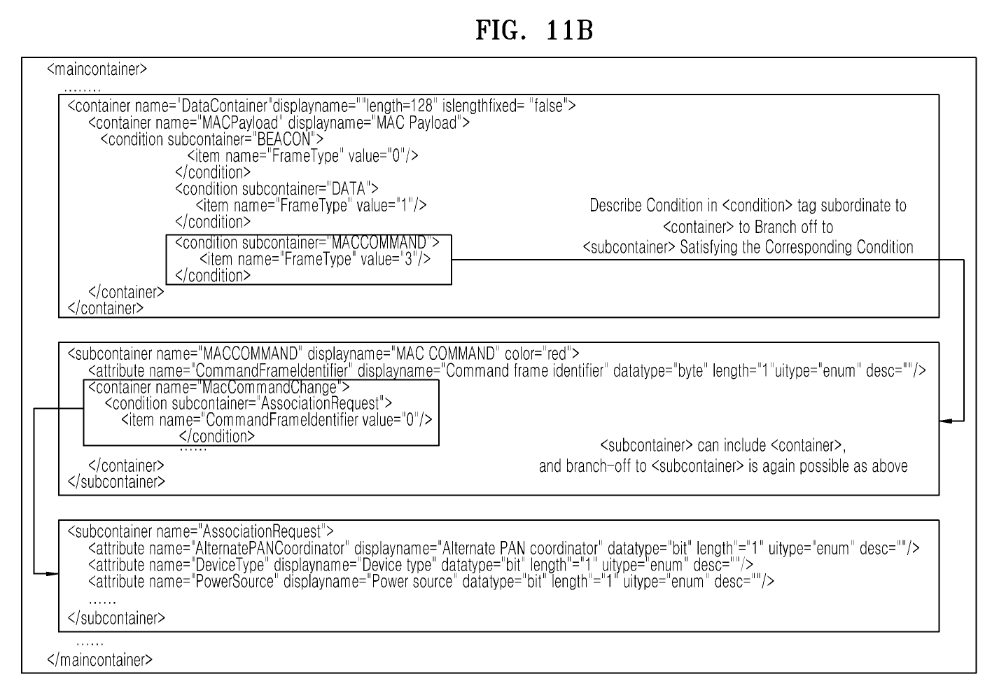

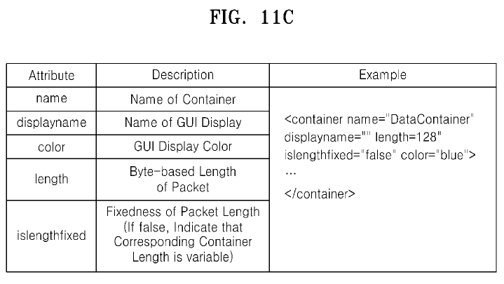

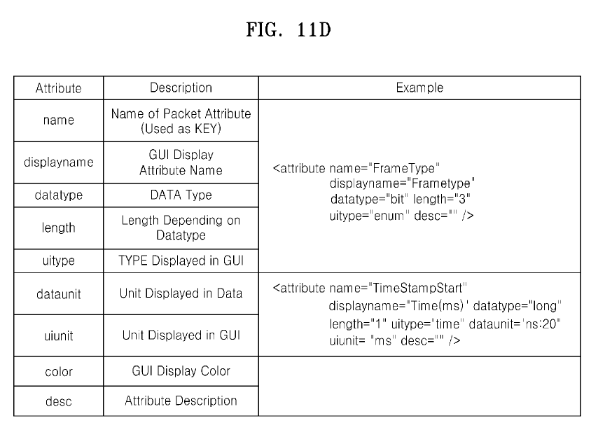

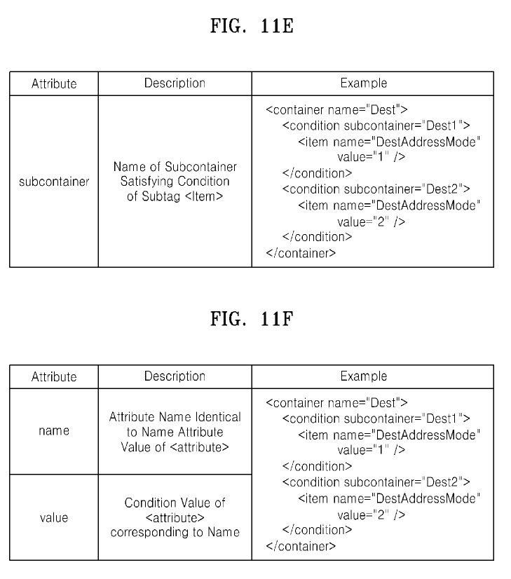

FIGS. 11A through 11F illustrate the detailed definition of packet attributes. FIG. 11A defines the attribute of a packet in a <MAINCONTAINER>˜</MAINCONTAINER> tag section. Herein, as illustrated in FIGS. 11A and 11B, <container> and <subcontainer> man include a sub <container> in a tree structure. The name of a tree node is determined according to the description or not of a display “name” for the <container> attribute. The <attribute> describes field information of a packet, and the corresponding <attribute> information may be accessed by a value written in “name”. For representation of a field with a variable packet length, the branch-off to suitable <subcontainer> is performed using a <condition> tag subordinate to a <container> tag. An <item> tag subordinate to the <condition> tag describes conditions, and the branch-off to <subcontainer> described in the subcontainer attribute of the <condition> is performed if the corresponding condition is satisfied. The <condition> describes only the condition for the existence of the corresponding container. FIG. 11C illustrates an example of the attribute and use of the <container> tag. FIG. 11D illustrates an example of the attribute and use of the <attribute> tag. FIG. 11E illustrates an example of the attribute and use of the <condition> tag. FIG. 11F illustrates an example of the attribute and use of the <item> tag.

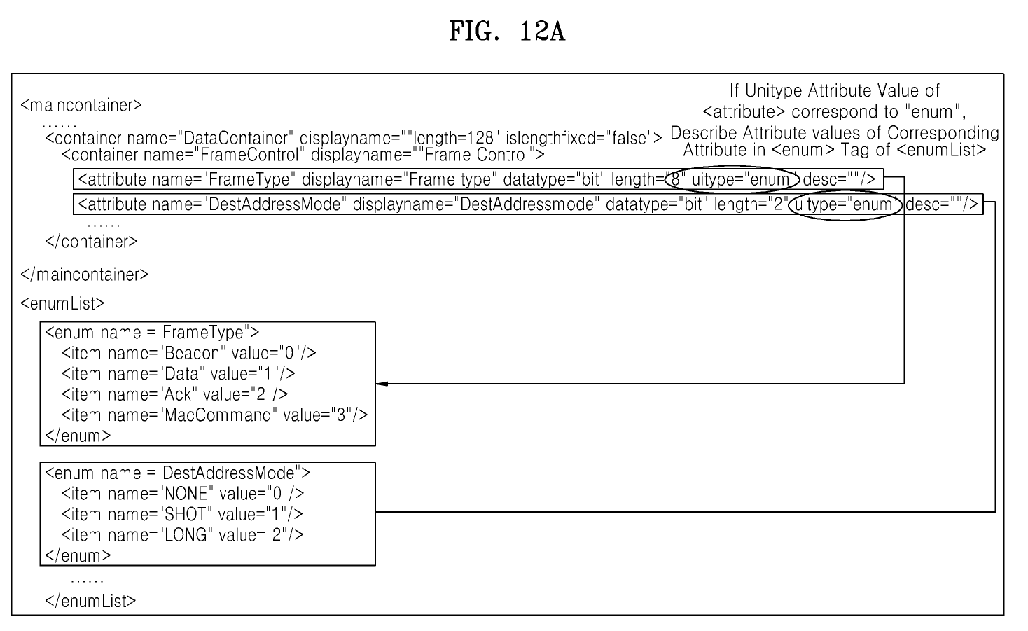

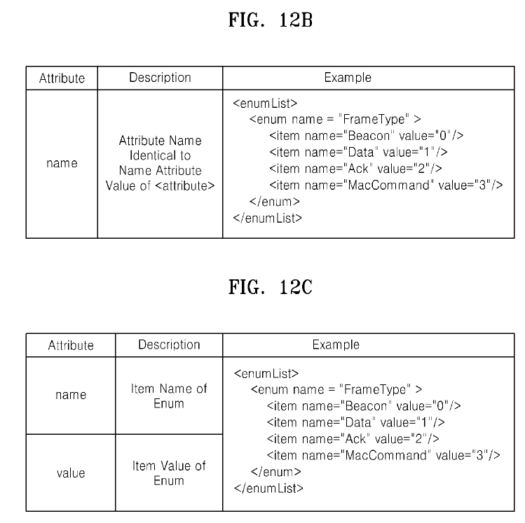

FIGS. 12A through 12C illustrate the detailed “enum” list of <attribute>. As illustrated in FIG. 12A, if a value written in “unitype” of <attribute> is “enum”, each item is obtained using an <enum< tag having the corresponding attribute name of <enumlist>. The “name” attribute value of the corresponding <attribute> is written in the “name” attribute value of <enum> of FIG. 12B. FIG. 12C describes the name and value of each attribute item of an <item> tag subordinate to an <enum> tag.

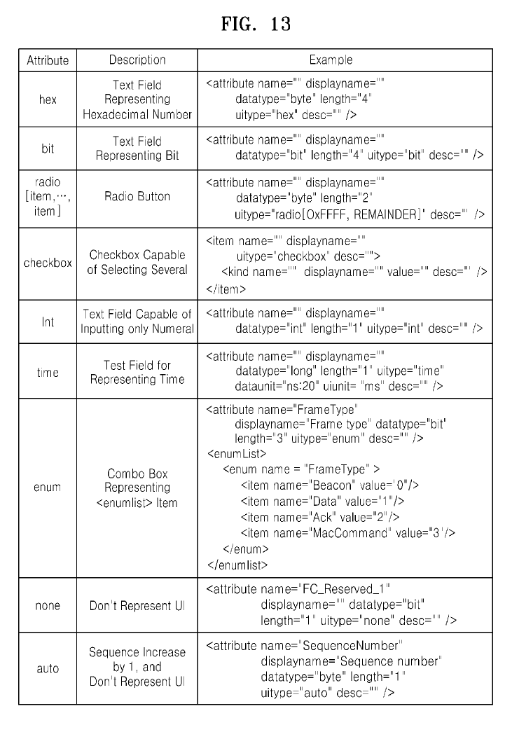

FIG. 13 illustrates a unitype for representing data in a graphic user interface according to an embodiment of the present invention, which is used as the <item> attribute of <collectionfilter> and <attribute>.

Referring again to FIG. 5, the protocol schema defines the USN protocol as illustrated in FIGS. 6A-6C through 12. The XML engine 510 generates an XML and a GUI through the protocol defined in the protocol schema 500. The XML engine 510 includes a protocol manager 511, a GUI generator 512, and an XML generator 513. The protocol manager 511 manages the USN protocol defined in the protocol schema 500. Managing the USN protocol means managing analysis of a plurality of protocol definitions according to a predetermined standard selected by the user, if there is a plurality of protocol schemas according to the protocol standards.

The XML generator 513 transforms the USN protocol, which is defined in the protocol schema 500, into an XML format. The resulting XML USN protocol is transferred to the translator 520, which will be described later.

The GUI generator 512 generates a GUI including a channel searcher 517, a packet collector 514, a packet generator 515 and a statistics collector 516. For example, packets are transmitted/received through the channel searcher 517, the packet collector 514, the packet generator 515 and the statistics collector 516 of the generated GUI, and a variety of statistic data may be written on a screen.

The translator 520 processes packets transmitted/received using the XML schema generated by the XML engine 510. For example, the translator 520 encodes/decodes packets transmitted/received through a decoder 521 and an encoder 523 that are included in the translator 520.

The packet manager 530 including a first socket 531 and a second socket 532 controls communication, and transmits/receives packets encoded/decoded by the translator 520.

The embodiments of the present invention can be written as computer programs and can be implemented in general-use digital computers that execute the programs using a computer readable recording medium. The data structure used in the embodiments of present invention can be recorded in the computer readable recording medium through various tools. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet).

As described above, the USN protocol analyzing apparatus according to the present invention includes the packet analyzer and the protocol analyzer. The packet analyzer collects packets communicated between USN sensor nodes through at least one or more channels. The protocol analyzer processes/displays the collected packets using an XML schema generated through a predefined USN protocol. Thus, the USN protocol analyzing apparatus can analyze a plurality of channels simultaneously and can analyze various protocols based on user definitions (e.g., XML schemas).

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for analyzing a USN protocol, comprising:
a packet analyzer collecting packets communicated between USN sensor nodes through at least one or more channels; and
a protocol analyzer processing/displaying the collected packets using an XML schema defined according to the USN protocol.

2. The apparatus of claim 1, wherein the packet analyzer comprises at least one or more transceivers, and collects packets communicated between USN sensor nodes through at least one or more channels.

3. The apparatus of claim 2, wherein the packet analyzer comprises:
a communication connector connected to the protocol analyzer to transmit/receive packets;
a memory storing the collected packets; and
a TX/RX engine performing a control operation for transmitting/receiving the collected packets to the protocol analyzer.

4. The apparatus of claim 1, wherein the protocol analyzer comprises a personal computer mounted with a user program comprising:
a protocol schema defining a USN protocol;
an XML engine defining an XML schema according to the defined USN protocol and generating a GUI; and
a translator encoding/decoding the collected packets using the defined XML schema.

5. The apparatus of claim 4, further comprising a socket manager transmitting/receiving the collected packets, wherein the translator uses the XML schema to decode the packet received through the socket manager.

6. The apparatus of claim 4, wherein the translator comprises:
an encoder analyzing the collected packets using the XML schema; and
a decoder decoding the packet received through the socket manager by using the XML schema so that the XML engine is able to generate the GUI.

7. The apparatus of claim 4, wherein the XML engine comprises:
an XML generator defining the XML schema according to the USN protocol defined by the protocol schema; and
a GUI generator generating the GUI using the XML schema defined by the XML generator.

8. The apparatus of claim 7, wherein the GUI generator generates the GUI comprising channel search, packet collection, packet generation, and statistics collection by using the XML schema defined by the XML generator.

9. The apparatus of claim 7, wherein the XML schema comprises a header section, a body section, and a maincontainer section.

10. The apparatus of claim 9, wherein the header section comprises a protocol name defined by a user, the maximum packet length, a protocol version, an XML authoring date, an XML file description, an author, and a company name.

11. The apparatus of claim 9, wherein the body section defines packet definition, RX option settings, and statistics.

12. The apparatus of claim 9, wherein the maincontainer section defines packet attributes.

13. The apparatus of claim 3, wherein the type of the communication connector is one of Ethernet, wireless LAN, USB, GSM and CDMA.

14. The apparatus of claim 1, wherein the USN protocol is a packet structure comprising: a field of the transceiver included in the packet analyzer; a field of a packet type used between the packet analyzer and the protocol analyzer; a reserved field commonly used; a field of a packet length indicating the data length of a packet; a field of start/stop time stamps; a data field for actual transmission/reception; and a CRC field.

15. The apparatus of claim 14, wherein the packet type comprises: a first packet type defining actually transmitted/received data; and a second packet type controlling the packet analyzer and the packet analyzer or defining the type necessary for reception of information from the packet analyzer.

16. The apparatus of claim 15, wherein the first packet type comprises:
a packet type “0x50” indicating transmission of padding from data; and
a packet type “0x51” indicating transmission of non-padding from data.

17. The apparatus of claim 15, wherein the second packet type comprises:
a packet type “0x60” indicating a request for entire reset of the packet analyzer;
a packet type “0x61” indicating a response to the request for the entire reset of the packet analyzer;
a packet type “0x62” indicating a request for IP setting of the packet analyzer;
a packet type “0x63” indicating a response to the request for the IP setting of the packet analyzer;
a packet type “0x64” indicating a request for state information of each channel;
a packet type “0x65” indicating a response to the request for the state information of each channel;
a packet type “0x66” indicating a logical channel setting request for a channel of the packet analyzer;
a packet type “0x67” indicating a channel setting response;
a packet type “0x68” indicating a time stamp reset request; and
a packet type “0x69” indicating a response to the time stamp reset request.
